(19) United States
(12) Patent Application Publication
(10) Pub. No.: US 2020/0105115 A1
(43) Pub. Date: Apr. 2, 2020

(54) SYSTEM AND METHOD FOR WEARABLE MONITOR WITH ACTIVITY MONITORING, FALL DETECTION AND DELEGATE NOTIFICATION

(71) Applicant: Centerpointe Senior Living, LLC, Newport Beach, CA (US)

(72) Inventor: Paul Habeeb, Newport Beach, CA (US)

(21) Appl. No.: 16/171,904

(22) Filed: Oct. 26, 2018

Related U.S. Application Data
(60) Provisional application No. 62/738,373, filed on Sep. 28, 2018.

(51) Int. Cl. G08B 21/04; G08B 21/18; G08B 5/22

(52) U.S. Cl. CPC G08B 21/043; G08B 5/223; G08B 21/0446; G08B 21/182

(57) ABSTRACT

The present system is directed in various methods, devices and systems relating to wearable devices for personal safety and emergency notification. More specifically, a wearable watch with a band that provides fall detection processing only after detecting a significant movement, emergency notification of an emergency service, a call to an emergency center and SMS message to designated delegates upon determining that a fall is detected. Fall detection processing only begins after a significant motion is detected. Once a significant motion is detected, then the device monitors motion for predetermined windows of time, develops waveforms for the monitored motion and compares the monitored waveform with a reference fall waveform. If the monitored waveform compares with the reference fall waveform at or above a predetermined comparison threshold, a fall is detected and declared.

### CROSS-REFERENCE TO RELATED APPLICATIONS

This application claims the benefit of U.S. Provisional Application Ser. No. 62/738,373, filed Sep. 28, 2018 and entitled SYSTEM AND METHOD FOR WEARABLE MONITOR WITH ACTIVITY MONITORING, FALL DETECTION AND DELEGATE NOTIFICATION, the entirety is which is incorporated herein by reference.

### FIELD OF THE INVENTION

The invention relates generally to the electronic monitoring of persons and their activities and status. More particularly, a wearable monitor with at least two sensors for collecting biological, motion and/or location information from the person wearing the monitor. Designated delegates may be located remotely from the monitored person and may be notified of emergency situations and view the collected information from their location which may be located remotely from the wearable monitor and the person wearing the monitor.

### BACKGROUND

A variety of systems and methods are known for monitoring a variety of characteristics of a person, including but not limited to vital signs, motion and fall detection and location. Many of these known systems and methods enable notification of an emergency center, a designated health care provider and/or a designated caregiver if an emergency condition is detected. Moreover, known systems and methods enable a delegate and/or health care provider to initiate a telemetry inquiry about the monitored person. These known systems and methods may continuously monitor telemetry such as location, heart rate, and the like, all of which spends battery life. This may be improved.

Further, known systems and methods notify all delegates and/or allow all delegates to initiate an inquiry, when they are identified and the system is activated. This is also subject to improvement. In addition, providing a system and method that allows the user to change call center numbers and/or provide different information to each of a plurality of call centers, or to 911, would be desirable. A rule-dependent and rule-driven system and method is highly desirable.

Moreover, known systems and methods may operate in a sleeping state as it relates to monitoring movement of the monitored person, waking to a more active state when an abnormal motion set is detected. Because many of the detected abnormal motion sets are not related to a falling situation, this change in state may be further optimized.

Generally, it would also be desirable to provide a system and method that, when an emergency is initiated by the wearer and/or a fall is detected, does the following: gets the location of the wearable device; sends an emergency event message to the emergency service; initiates a phone call to an emergency center—most preferably the closest emergency center, and sends SMS messages to each designated delegate.

The present invention overcomes these deficiencies and provides, inter alia, the above-referenced improvements.

### BRIEF SUMMARY OF THE INVENTION

The present system is directed in various methods, devices and systems relating to wearable devices for personal safety and emergency notification. More specifically, a wearable watch with a band that provides fall detection processing only after detecting a significant movement, emergency notification of an emergency service, a call to an emergency center and SMS message to designated delegates upon determining that a fall is detected. Fall detection processing only begins after a significant motion is detected. Once a significant motion is detected, then the device monitors motion for predetermined windows of time, develops waveforms for the monitored motion and compares the monitored waveform with a reference fall waveform. If the monitored waveform compares with the reference fall waveform at or above a predetermined comparison threshold, a fall is detected and declared.

### BRIEF DESCRIPTION OF THE DRAWINGS

FIG. 1 is a block diagram of exemplary wearable device components of the present invention;

FIG. 2 is a block diagram and flow chart for an exemplary system of the present invention;

FIGS. 3A-3J are a series of displays for a wearable device of the present invention;

FIG. 4 is a flow chart for a device startup process of the present invention;

FIG. 5 is a flow chart for an emergency process of the present invention;

FIG. 6 is a flow chart for dashboard interaction of the present invention;

FIG. 7 is a flow chart for a fall process of the present invention;

FIG. 8 is a flow chart for a fall detection process of the present invention;

FIG. 9 is a flow chart and block diagram for a fall detection process of the present invention.

FIG. 10 is an exemplary set of acceleration fall data for the present invention;

FIG. 11 is an exemplary set of acceleration fall data for the present invention;

FIG. 12 is an exemplary set of acceleration fall data for the present invention;

FIG. 13 is an exemplary set of acceleration fall data for the present invention;

FIG. 14 is an exemplary set of acceleration fall data for the present invention;

FIG. 15 is an exemplary set of acceleration fall data for the present invention;

FIG. 16 is an exemplary set of acceleration fall data for the present invention; and

FIG. 17 is an exemplary set of acceleration fall data for the present invention.

### DETAILED DESCRIPTION

While the invention is amenable to various modifications and alternative forms, specifics thereof are shown by way of example in the drawings and described in detail herein. It should be understood, however, that the intention is not to limit the invention to the particular embodiments described. On the contrary, the intention is to cover all modifications, equivalents, and alternatives falling within the spirit and scope of the invention.

Various embodiments of the present invention comprise a wearable device comprising motion detection, fall detection, emergency assistance request, location detection, cellular and Wifi communication modules, a heart rate sensor, a display and power management module including a rechargeable battery.

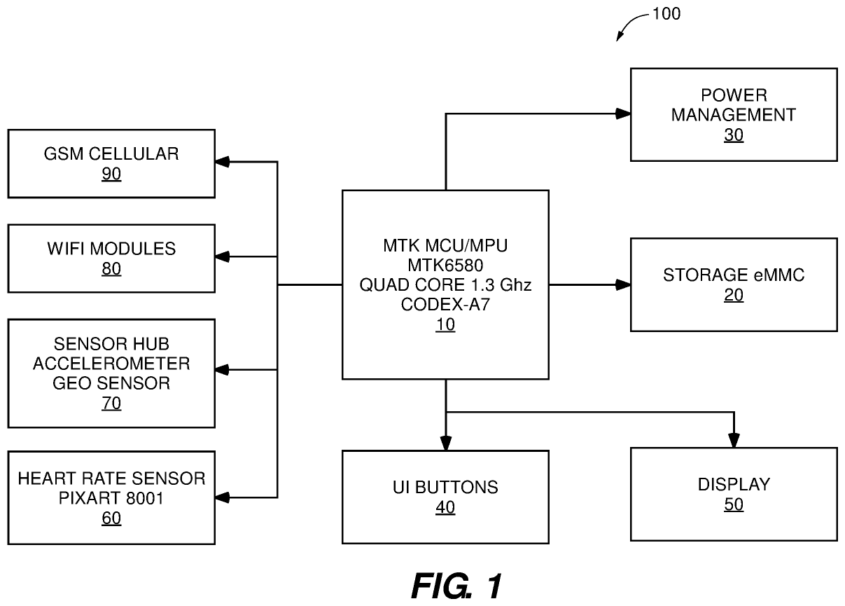

FIG. 1 is a basic structural block diagram of the component elements of the wearable device 100. A central processor 10 is provided to, inter alia, access and execute programmed instructions or code that may be stored on the device's internal memory 20. A power management module 30 is provided that enables the device to operate in a low power state for much of the time, with certain exceptions described further infra. User interface buttons 40 and a display 50 are provided in operative communication with the processor. The processor 10 is in further operative communication with a heart rate sensor 60, a sensor hub 70 comprising an accelerometer, gyroscope and geolocation sensor, a Wifi module 80 and a GSM cellular module 90 as shown. Thus, the wearable device, e.g., a watch, comprises a number of functional features including, but not limited to: motion and/or orientation detection, location detection, heart rate sensing, Wifi connection, the ability to make and receive phone calls (the device 100 further comprises a microphone and speaker to facilitate voice calls) and SMS text messages using the cellular connection and calling module 90, and the ability to execute pre-programmed instructions and/or issue alerts to the wearer of device 100 and/or delegates designated by the wearer of device 100, wherein the delegates may be remotely located. The preferred device 100 comprises an operating system (OS) that, in a preferred embodiment, comprises an Android OS, e.g., Android 7.0. Other operating systems will readily present themselves to the skilled artisan, each of which are well within the scope of the current disclosure and invention.

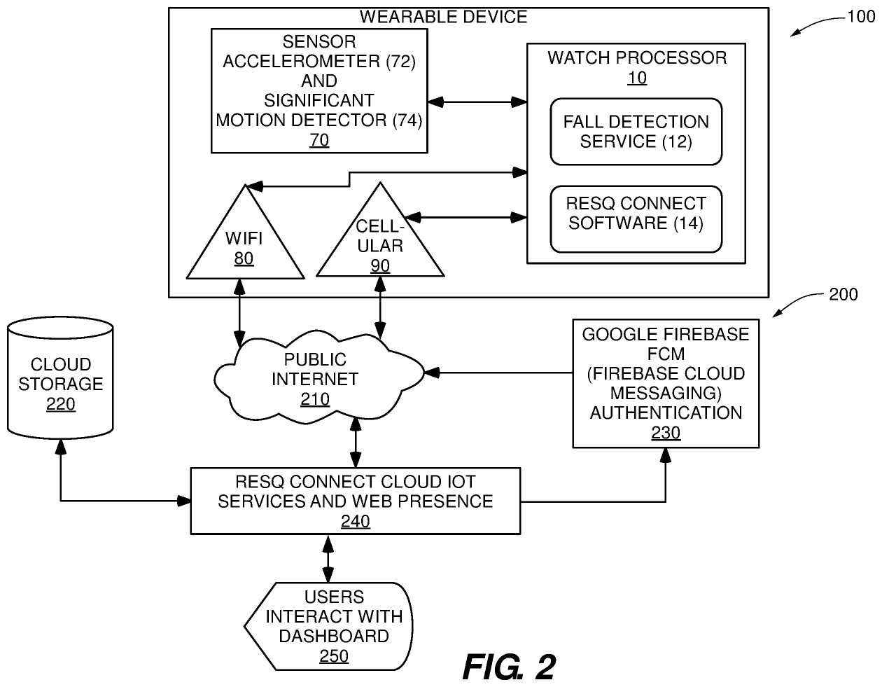

FIG. 2 is a diagram illustrating the system architecture and basic information flow 200 of the subject invention. Thus, the wearable device 100 comprises the elements of FIG. 1 and is enabled via either Wifi or cellular communication modules to communicate with the internet. The modules or elements of device 100 shown in FIG. 2 are the device processor 10, comprising a fall detection service 12 and software designated as ResQ Connect software 14. Processor 10 is shown in operative two-way communication with the sensor hub 70, comprising an accelerometer 72 and significant motion detector 74. Processor 10 is further in operative two-way communication with the Wifi 80 and Cellular 90 modules. More specifically, the fall detection service 14 of processor 10 is in operative communication with the Wifi module 80 and the sensor hub 70 comprising the accelerometer 72 and significant motion detector 74. Further, the ResQ connect software module 14 of processor 10 is in operative communication with the cellular module 90 as shown.

The wearable device 100 communicates with remote services and/or individuals using the internet and cloud-based system 200 of FIG. 2. Thus, related cloud services and website are accessible via the internet 210 as is cloud-based storage 220. Google Firebase Cloud Messaging (FCM) authentication 230 is provided and accessed through the internet 210 and/or the related cloud services and/or designated access website 240. Users, including remote users such as delegates or emergency personnel may access the website 240 with authorized entry to see an information dashboard 250 relating to the specific wearable device 100. Information and/or communication between the elements of system 200 are indicated by the arrows in FIG. 2.

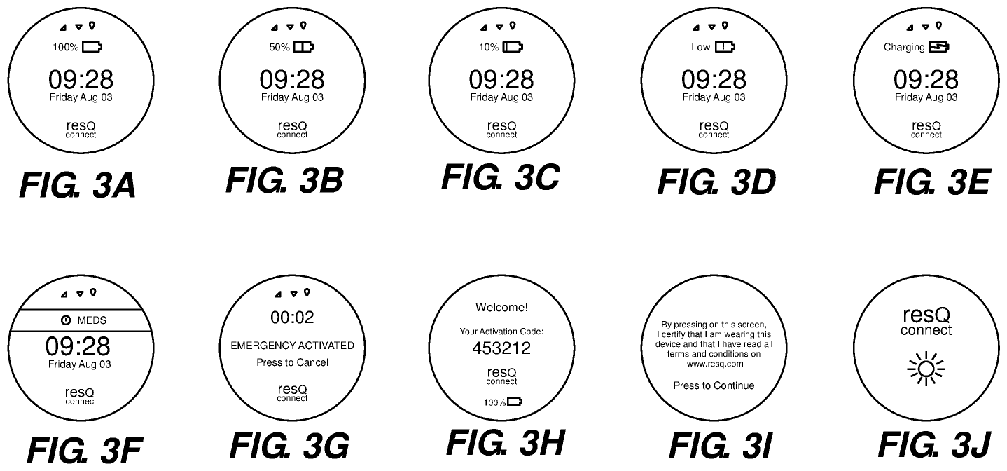

FIGS. 3A-3J illustrate a set of exemplary display 40 interfaces and messages that may be defined and/or programmed for the wearable device 100. Thus, as shown in FIGS. 3A and 3B, the time, day and date are provided as is a battery charge indicator. A low battery visual indicator is shown in FIGS. 3C and 3D at 10% or lower as is an indicator that the battery is charging in FIG. 3E. Event timers may be actuated, e.g., a MEDS indicator to remind the user to take medication as illustrated in FIG. 3F. FIG. 3G illustrates, and as discussed further below, the display actuating an EMERGENCY ACTIVATED message with a further indication that the emergency activation may be canceled by pressing the screen if done before the countdown timer (shown at 00:02 seconds) reaches 00:00. Additional screens provide the user's specific activation code (FIG. 3H) and confirmation of reading the terms and conditions located on the related website (FIG. 3I) and an image of a shutdown screen at FIG. 3J.

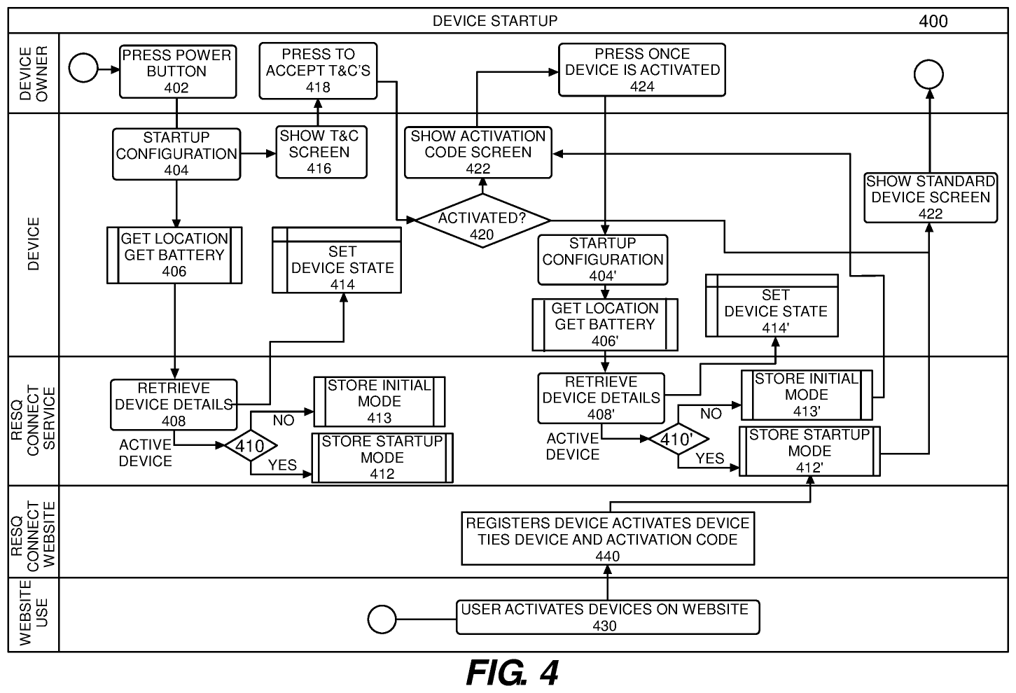

FIG. 4 illustrates the basic functional flow on device startup 400. Pressing the power button 402 results in initiation of startup configuration at 404 and getting the location information for the device and battery status at 406. When this step is complete, device details are retrieved from the remote or cloud-based server and service at 408. The device details are then transmitted to the device where the device state is set at 414. The remote or cloud-based server and service further determines the activity status of the device based on the device details at 410. If the device is determined to be active, then the startup mode is stored at 412, if the device is determined to not be active, then the initial mode is stored at 413.

Initiation of startup configuration at 404 further results in displaying a set of terms and conditions screen on the wearable device's display at 416 which may be accepted at 418.

The device 100 then queries whether it has been activated at 420. If activated, the standard device screen of, e.g., FIG. 3A may be shown at 422.

If the device has not been activated, the user is required to activate the device by moving through the startup configuration steps as illustrated. First, the activation code screen is displayed on the wearable device screen as seen in FIG. 3H, at 424 with actuation at 426, the device 100 then enters startup configuration wherein the steps 404′-414′ comprising the same steps as previously described 404-414 are executed. Once the device is activated, step 430 requires a user to activate the device on the website 240 discussed above in connection with FIG. 2. Then at 440, the website enables registration and activation of the device, tying the device with the activation code at 450

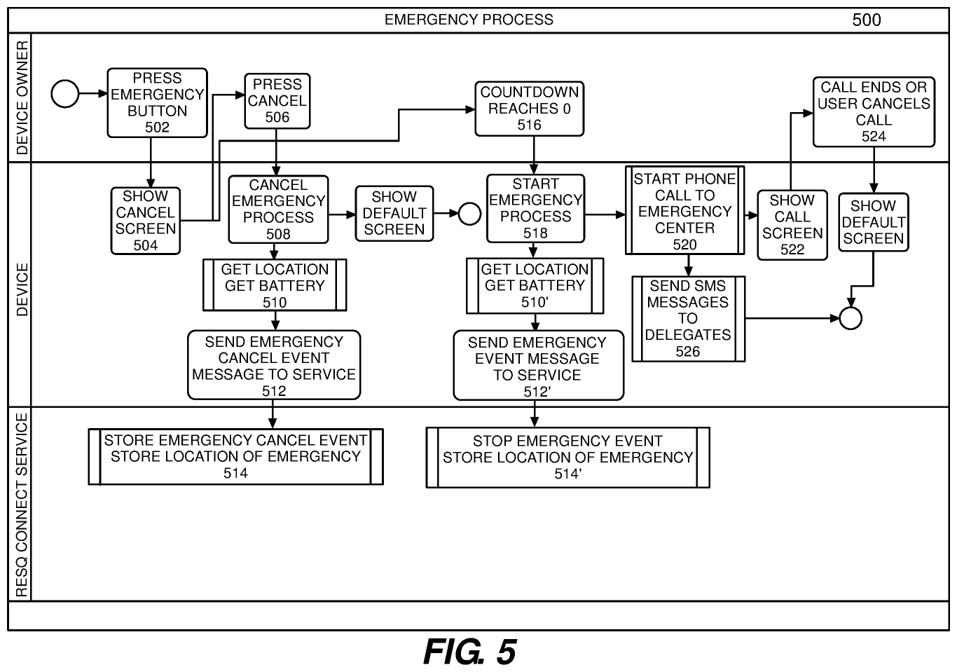

We turn now to the handling of a manually actuated emergency process 500 illustrated in FIG. 5. This emergency algorithm is initiated by pressing the emergency button on the device, either by a wearer of the device or another person at step 502. A “cancel” screen is shown and a countdown commences (see FIG. 3G) at step 504, during which time the emergency process may be canceled by pressing the cancel feature on the device at 506. In the event the manually actuated emergency process is canceled at 508, the device gets the location of the device and the battery status at 510 and also sends the emergency cancel event to the remote or cloud-based server or service 512 where it is stored together with the location of the device during the emergency countdown and cancellation at 514. This data is stored to provide diagnostic information that may be helpful in cases where several to multiple emergency cancellations occur. For example, this information may be accessed by designated delegates and/or health care providers and found useful when determining why the multiple cancellations are occurring and whether something can be done to help reduce the number of them.

If the countdown reaches “0” as in step 516, then the device initiates an emergency process 518 which comprises two major elements. First, the location of the device, using a GPS locating sensor integrated into the device, and the battery status are queried, obtained and sent to the remote or cloud-based server or service where these data are stored at 510′, 512′ and 514′. Second, a notification chain is initiated. A phone call is started to the designated emergency center to allow voice interaction between the emergency center and/or the designated health care provider and the wearer of the device or other person assisting the wearer of the drive at step 520. Initiation of phone call at 520 results in displaying the call screen at 522 and ultimately an end to the call at 524. In addition, SMS messages are sent to the designated delegates alerting them of the manually actuated emergency at 526.

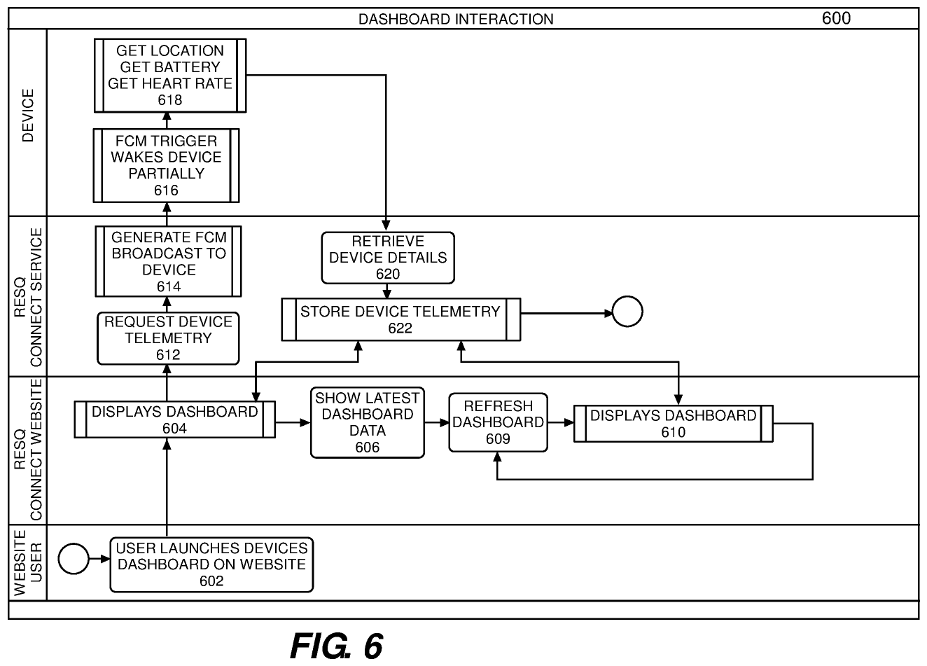

The wearable device further comprises an optical sensor for monitoring the heart rate of the wearer. However, unlike known devices, this feature is only initiated upon remote inquiry by a designated delegate and/or healthcare provider or other person with access to the website and the user's unique information as shown in dashboard interaction process 600 in FIG. 6. Thus, when the device dashboard of the person wearing the device is accessed at the website by an internet-connected device at 602, the dashboard for the person's device is displayed on that internet-connected device at 604. This information comprises the latest dashboard data 606 and may be updated by refreshing the dashboard 608, 610.

If desired, the device's telemetry, e.g., device location, battery status and/or heart rate of the designated wearer of the device 100 may be requested from the website dashboard via the remote or cloud-based server or service as shown. In response to a device telemetry inquiry or update, the remote or cloud-based server or service generates a message via firebase cloud messaging (“FCM”) as is well-known to the skilled artisan as in 614. The generated FCM message is communicated to the wearer's device at 616 which, when received, partially wakes the device which is otherwise normally in a low activity or sleep state 618. At this point, the device gets its location, gets its battery status and now and only now gets a heart rate from the patient at an exemplary optical sensor at 618. This information is provided to the remote and cloud-based server and service upon initiating of a retrieve device details function 620 and the data is further stored at the remote and cloud-based server and service at 622. Next, the dashboard at the website may update on its own, or may be refreshed by the user, to show the obtained information, including the patient's heart rate as discussed above. Confirmation of the heart rate in this manner also confirms that the device is being worn and therefore, in combination with the GPS locating sensor data also accessible at the website dashboard, also further confirms the location of the person wearing the device.

Only getting the telemetry data, i.e., location and heart rate, in the above process, and then only initiated by a user of the website, operates to save battery life. The device waits for the FCM message and then only partially wakes up to obtain the requested telemetry data, thus saving battery life.

It is another feature of the present system and method that designated delegate(s) receive an SMS message if the battery reaches a predetermined “low” point, for example, the low battery charge point may be set anywhere between 5% and 25%. This allows the designated delegate(s) to contact the wearer of the device and/or a local assistant who can then ensure the device is charged.

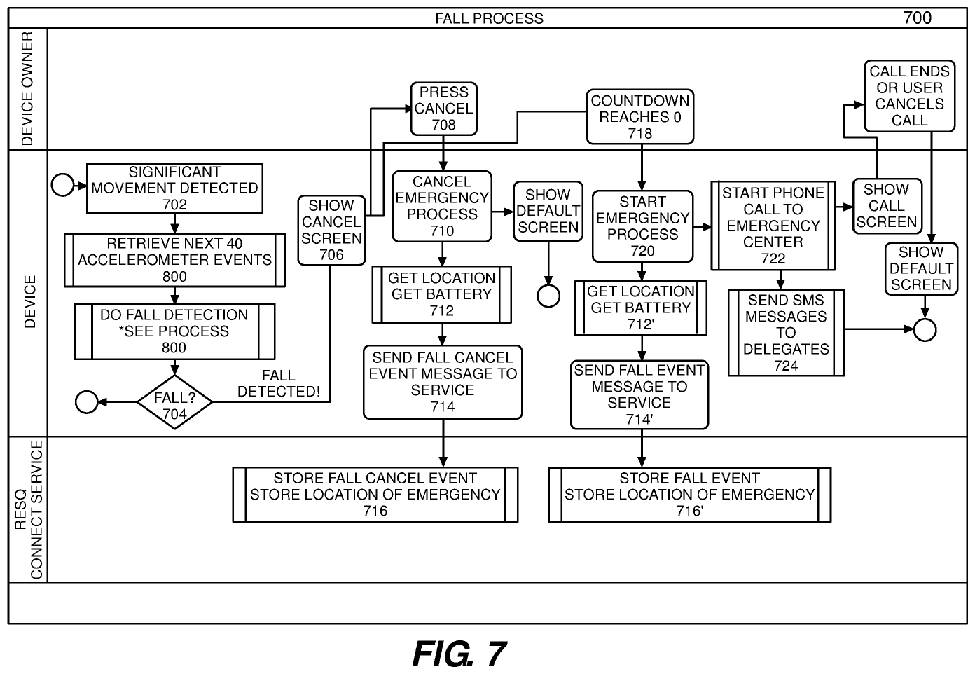

We now turn to the motion monitoring and fall detection processes 700 of the inventive system and method as described in relevant part in FIG. 7. Minimizing battery drain is paramount in this process, so the device monitors motion while in the low activity, sleep state until confirmation of a fall is obtained.

A motion sensor hub 700 comprising a gyroscope and an accelerometer, preferably a 3-axis accelerometer is provided in operative communication with the device's processor and memory as shown in FIG. 1. An exemplary motion sensor is manufactured by Bosch, model BH160™ which is a low-power smart hub comprising a 3-axis gyroscope and an integrated 3-axis accelerometer. Thus, the motion sensor is capable of monitoring the rate of rotation of the device in space, i.e., the roll, pitch and yaw, as well as linear motion and gravitational forces in the x, y and z dimensions.

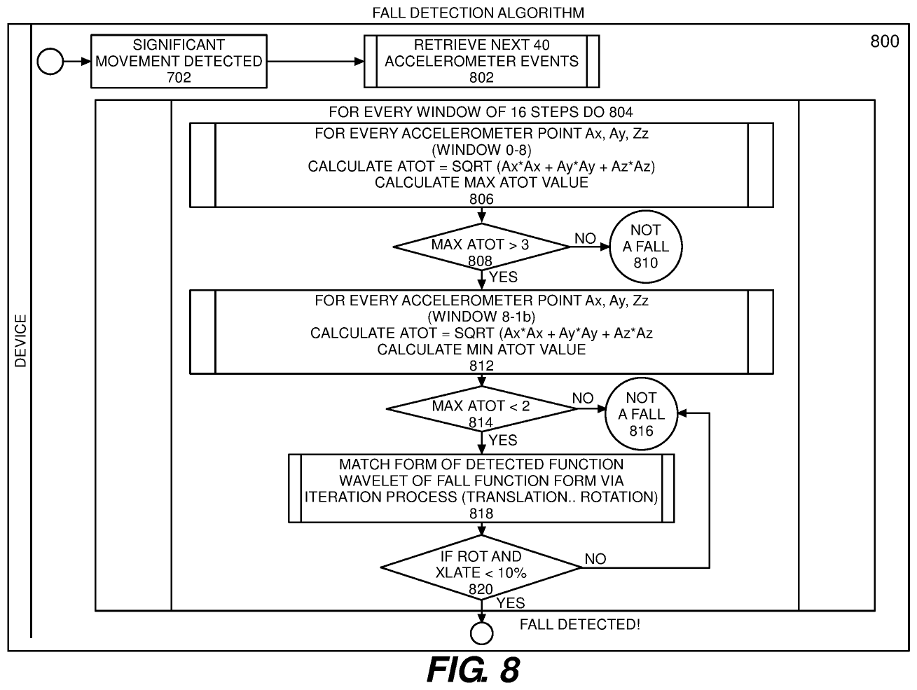

With reference now to FIG. 7, a significant movement threshold is predetermined and set within the device (not shown). As the device moves freely in space, the gyroscope and/or the 3-axis accelerometer of the motion sensor monitors the three-dimensional movements. If at least one movement is detected that exceeds the significant movement threshold at 702, the fall detection process at 800 (see FIG. 8) is initiated with monitoring of at least the accelerometer data provided by the motion sensor. Significantly, the device is not woken to a higher activity state until a fall is detected. During the fall detection process, the device is kept in a low power mode to save battery life.

If a fall is detected, i.e., confirmed, at 704, then a cancel screen appears on the device and a countdown initiates which lasts a predetermined time, e.g., 10 seconds at 706. If the cancel feature is actuated, e.g., a button is pressed, at 708, then the related emergency process is cancelled at 710, the battery status and location of the device are obtained at 712 and a fall cancellation message is sent to the remote or cloud-based server and service at 714 where it is stored for future reference and analysis if needed at 716.

If, however, the cancellation countdown reaches “0” as at 718, then the fall emergency process is initiated 720 by getting the device's location and battery status 712′. When this is completed, a fall event message is sent to the remote or cloud-based server and service 714′ where it is stored 716′. Initiation of the fall emergency process also comprises starting a phone call to the designated emergency center or health care provider 722 and an SMS message is sent to the designated delegate(s) 724 as those processes are described in connection with the emergency processing 500 of FIG. 5.

As discussed above in connection with FIG. 7, the fall detection process 800 is initiated only after a significant movement is detected that exceeds the significant movement threshold 702. At this stage as shown in more detail in FIG. 8, the device 100 measures a plurality of x,y,z acceleration vectors, using the accelerometer of the motion sensor, occurring after the significant movement is detected at 802. For example 40 post-significant movement x,y,z acceleration vectors may be measured and stored in the device's memory and logged to storage on the device for error detection and analysis by the device's processor 10 using pre-programmed instructions stored on the device's internal memory 20. The processor 10 enables sensor trigger events to return accelerometer readings at a specified rate per second. The processor 10 sends a command to the accelerometer of the sensor hub 70 to return the data and the device processor calls the related programmed instructions or code as each data tuple (x, y, z) becomes available.

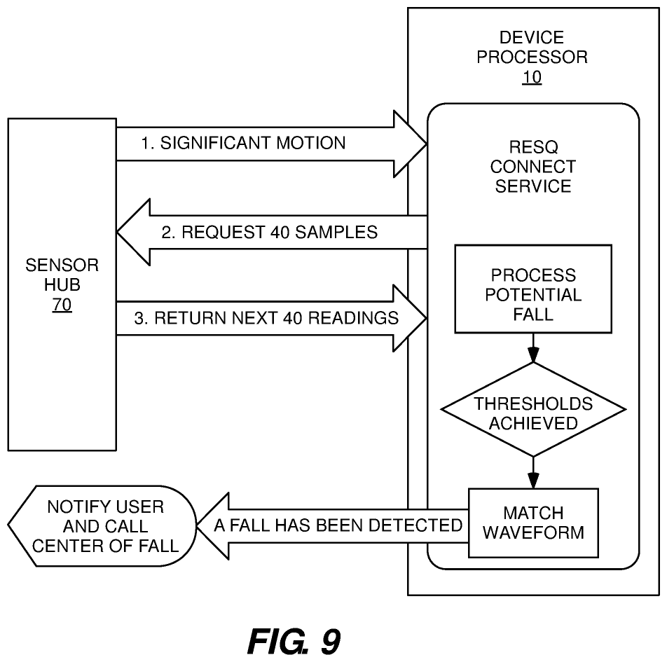

Once the plurality of post-significant x,y,z acceleration vectors has been captured by the motion sensor's accelerometer, the data is processed and analyzed on the processor using programmed instructions or code according to the following steps and as shown in FIGS. 8 and 9:

1. Two force vector thresholds are established and stored in the device's internal memory. Thus, a pre-event threshold value and a post-event threshold value are established.

If the pre-event threshold value is exceeded, then an initial free fall is detected. If the pre-event threshold is not exceeded, then a free fall is not detected.

An exemplary pre-event threshold value (or upper threshold value) may comprise approximately 30 m/s² or approximately 3 G's of force. An exemplary post-event threshold may comprise approximately 20 m/s² or approximately 2 G's of force.

If the post-event threshold value is not met, i.e., the force vector data is below the post-event threshold, then it is determined that the device (and the wearer) are at rest, potentially after having fallen. If the post-event threshold value is not exceeded, then the device's processor sets a global indicator, indicating that a potential fall is detected and that the accelerometer data must be analyzed to determine and validate if a real fall event has occurred.

2. The force vector is calculated for each of the plurality of post-significant x,yxz acceleration vectors using the following equation:

Vtot=(x²+y²+z²)⁵. See step 806.

3. A two-part moving window is established at 804 using a subset of the plurality of post-significant movement acceleration data. The first part of the moving window may consist of 8 data points and established as the pre-event data set of the moving window. The second part of the moving window may comprise the next set of data points in the plurality of post-significant movement acceleration data and established as the post-event data set of the moving window. The skilled artisan will recognize that 8 data points for each window component is merely exemplary and that the window components may comprise more or less data points. It is preferable that the pre-event and post-event data sets consist of an equivalent number of data points, though this is not a requirement. Thus either the pre-event or post-event data set may comprise a larger number of acceleration data points than the other data set.

4. Once the two-part moving window is established, the pre-event data set is analyzed on the device's processor 10 using programmed instructions stored in the memory to detect if the data set has a value that is greater than the established pre-event threshold value to potentially identify an initial free fall of the device at 806. If the pre-event threshold of, e.g., 3 G's of force is not met in pre-event comparison step 808, then it is concluded that this window of data is not consistent with a fall at 810. If, however, the pre-event threshold is met or exceeded, then the analysis continues to step 812.

5. Thus, at 812, the post-event data set portion of the moving window is analyzed at to detect if it has a value that is less than the established post-event threshold value to potentially detect the device at rest which may occur in some cases after a fall. Thus, as shown in post-event comparison step 814, if the post-event threshold of, e.g., 2 G's of force, is exceeded, then it is concluded at 816 that the data in this portion of the window is inconsistent with a fall.

If, however, the post-event data indicates that the exemplary 2 G's of force is not met within the window of data, then a fall may be detected and may be handled as in FIG. 7 or may be further confirmed as below.

6. If the threshold values in step 4, or steps 4 and 5, is/are met, then the angle between the first point (U) and the last point (V) in the pre-event data set may in some embodiments be calculated, where

U=[x₁, y₁, z₁] and V=[x₈, y₈, z₈], as follows:

Cos Theta=dot(U, V)/Norm(U)×Norm(V)); and

Theta InDegrees=a cos d(Cos Theta).

If the Theta InDegrees value is determined to be greater than an established threshold angle (Tfall), then the algorithm determines that a fall has potentially occurred and may be handled as in FIG. 7.

7. In other embodiments, concluding that a fall has been detected in both the pre-event and post-event data windows, may result in waveform validation, discussed in detail infra, is subsequently performed to confirm whether a fall has occurred. See step 818 and step 820 where the conformance of the test waveform within the designated data window to a reference known-fall waveform is tested. If the percent of conformance is greater than a predetermined threshold, e.g., 90%, then the detected fall is confirmed and handled as in FIG. 7.

FIG. 9 provides a block diagram illustrating the data flow during the fall detection process, beginning with detection of a significant motion event as described above, with data flow occurring between the processor 10, sensor hub 70 and with notification as in FIG. 7 of a potential fall detected.

The moving window may, as discussed above, comprise 16 data points (8 pre-event and 8 post-event) for each analysis. The window “moves” down the plurality of acceleration data points, searching for values that exceed the preset pre-event threshold and/or that are below the preset post-event threshold. Thus, analysis 1 may comprise events 1-16, analysis 2 may comprise events 2-17, analysis 3 may comprises events 3-18, etc., wherein each analysis determines whether or not a fall may have occurred.

The waveform validation process comprises the following steps:

1. A series of data from a pre-event data set and the related post-event data set of the moving window discussed above is selected.

2. A continuous wavelet transform is applied to the selected data set. In this connection, a base wavelet is provided that is representative of a fall. The base wavelet may be created based on analysis of previously obtained fall data.

3. The wavelet transform then analyzes whether a waveform of the selected data set is similar to, or different from, the base waveform.

4. The results of this analysis and comparison against the base waveform enables classification of the analyzed waveform as a fall or not a fall. If the analyzed waveform is determined to be similar to the base waveform (fall), then the event is classified as a fall.

Generally, a moving analysis window as discussed and described herein may comprise a size in x-axis units of an exemplary 8 steps before the center and 8 steps after the center of the waveform or wavelet. Thus, a total of 16 steps along the x-axis may be employed for the moving window approach which equates to 16 steps×640 ms (0.640 of a second).

In the embodiments using the reference fall waveform or wavelet to detect a fall or confirm a fall detection, a continuous wavelet transform is calculated between the reference fall waveform or wavelet to get the best translation and rotation that will fit the reference fall waveform or wavelet to the data's waveform or wavelet analyzed within the analysis window. Then, the reference fall waveform or wavelet and the waveform within the analysis window are integrated to obtain the space underneath the two waveforms, then a comparison of the size of the space is done. If the size of the common space is greater than a predetermined matching threshold, e.g., 90%, then a fall is detected.

These analysis tools and techniques are illustrated below in a series of Fall Detection Working Examples.

### FALL DETECTION WORKING EXAMPLES

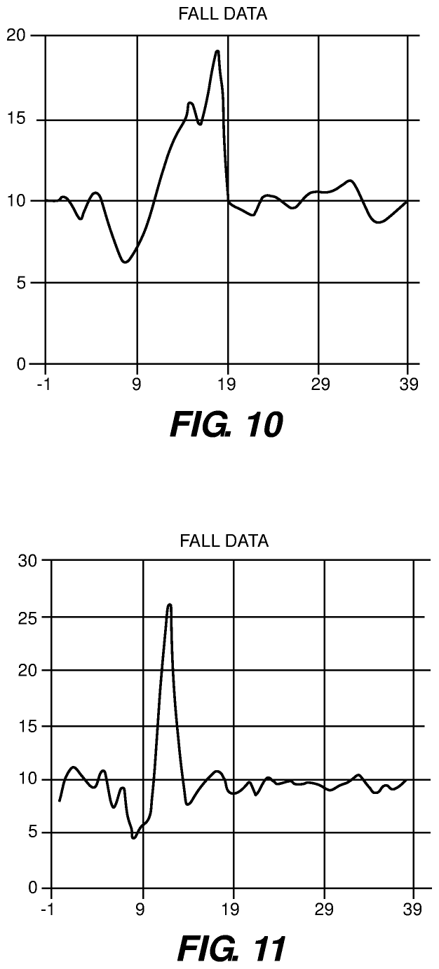

Working Example 1, illustrated in FIG. 10, wherein the x-axis provides the exemplary 40 readings from the accelerometer described above after detection of significant motion and the y-axis provides the square root of the sum of the squares of the three accelerometer readings (x,y,z). The x and y axes units are the same for each of the following Working Examples. In order for a fall to be detected according to embodiments of the present invention, the peak value must exceed the exemplary predetermined upper threshold of 30 m/s² (3 G) and the waveform must subsequently remain below the exemplary minimum or lower threshold of 20 m/s² (2 G). It is sufficient to determine that a fall did not occur if the peak value does not exceed the upper threshold, even though the waveform ends below the lower threshold.

FIG. 10 illustrates motion waveform data wherein the initial upper threshold of 30 m/s² (3 G) is not met. The maxima or peak value is roughly 19 m/s which is lower than the predetermined upper threshold of 30 m/s² (3 G). Therefore, the activity is determined to not be a fall in accordance with the processes described above.

Similarly, Working Example 2 shown in FIG. 11 illustrates the maxima or peak value at approximately 26 m/s², a value below the predetermined upper threshold of 30 m/s² and, therefore, the device concludes that a fall was not detected with associated processes as described above.

Working Examples 1 and 2 provide a fall detection embodiment comprising only the upper and lower predetermined thresholds, whereby if the threshold requirements are met, a fall is detected and if the threshold requirements are not met, no fall is detected.

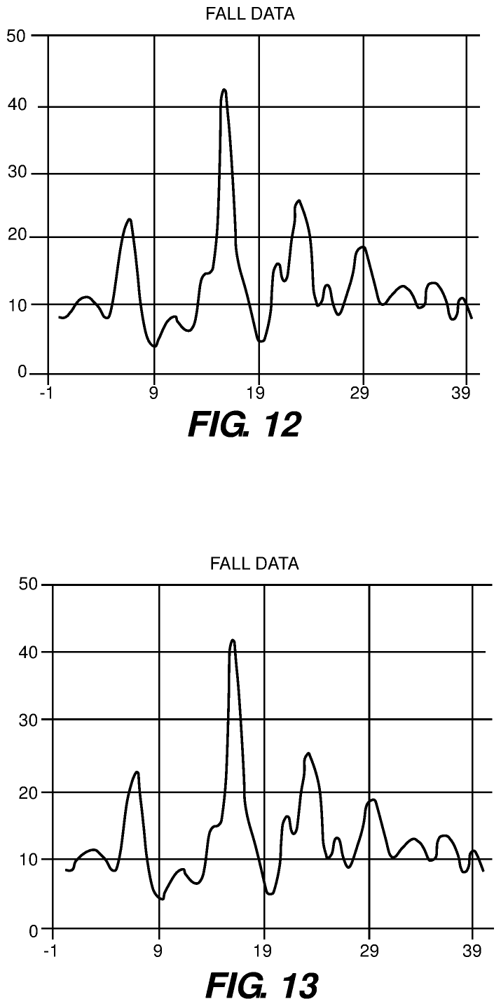

Working Example 3 illustrated in FIG. 12, shows the waveform comprised of fall data exceeding the predetermined upper threshold (30 m/s²) and then subsequently remaining below the predetermined lower threshold (20 m/s²). This waveform will, in certain embodiments considering only the upper and lower thresholds in the fall detection, detect a fall according to the processes described further above.

However, a further refining and/or confirmatory step may be taken to determine if the waveform of FIG. 12 is indeed to be considered a fall. Thus, FIG. 13 illustrates Working Example 4 as a modification of Working Example 3, with the added effect of a moving analysis window on Working Example 3 and the waveform data shown in FIG. 12. The shaded region in FIG. 13 now indicates the moving window discussed above wherein the waveform exceeds the lower threshold of 20 m/s² after exceeding the predetermined upper threshold of 30 m/s². Thus, for this particular moving window, a fall would not be detected and at least for the movement associated with the highlighted moving window, the event would be a false positive but for the effect of the moving window. Using this confirmatory analysis, the conclusion above in Working Example 3 that a fall was detected may be considered a “false positive.”

Thus, generally as the moving window progresses along the y-axis according to the fall detection algorithm discussed above, if the waveform data peaks above the upper threshold then stays below the lower threshold, a fall may be detected.

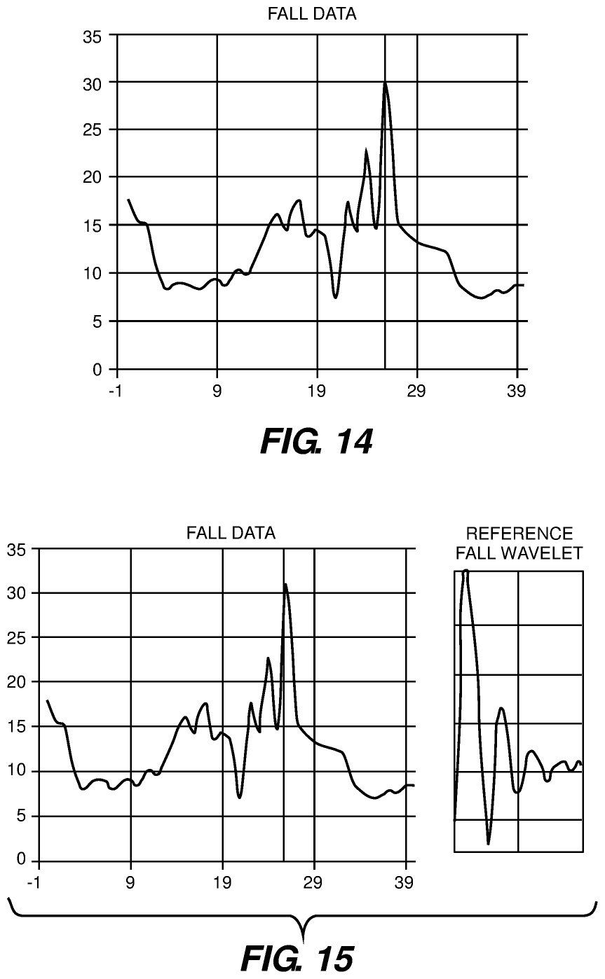

Working Examples 5 (FIG. 14) and 6 (FIG. 15) shows an additional confirmation of fall methodology by combining the upper and lower thresholds approach of Working Examples 1 and 2, the moving analysis window of Working Example 4 and wavelet form comparison. Thus, applying the upper threshold and lower threshold analysis within the moving window (shaded region), a fall is detected: the upper threshold of 30 m/s² is exceeded and the waveform data remains below 20 m/s² within the shaded moving analysis window.

Turning now to Working Example 6 in FIG. 15, when the waveform within the moving analysis window of Working Example 5 (FIG. 14) is compared with a reference fall wavelet known to represent a clear fall movement, Working Example 5 is determined to not match known fall movement data as represented by the reference fall wavelet and, therefore, the movement is not determined to be a fall. Therefore, the determination of a fall using upper and lower thresholds and the moving window is now determined to be a “false positive.”

The degree of matching between the reference wavelet and the movement waveform needed to indicate a fall may be fixed at a greater than an exemplary 90% match, though other match thresholds may be used effectively.

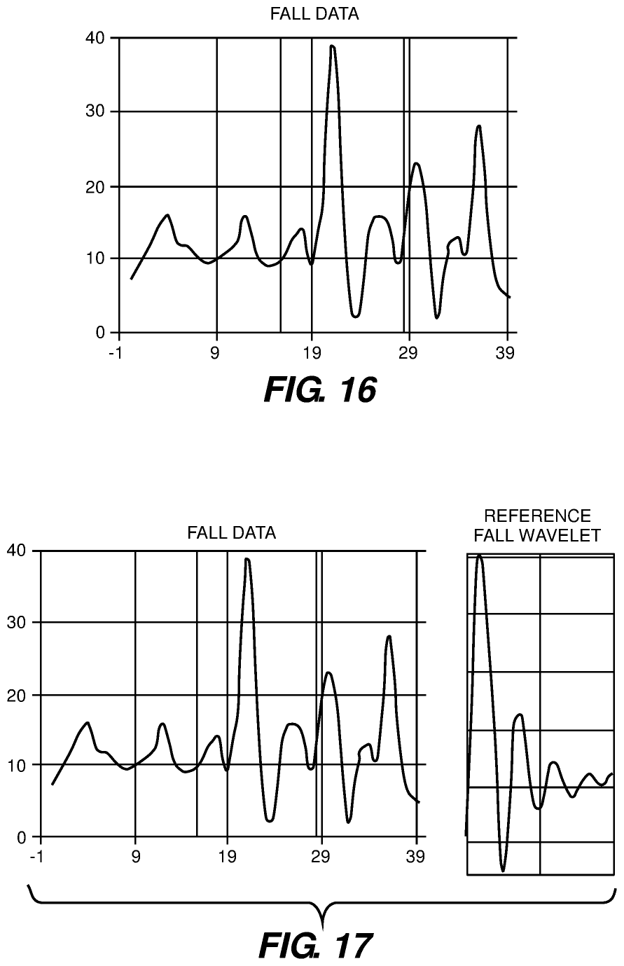

Working Example 7 is shown in FIG. 16. In this case, a potential fall is detected with the upper and lower threshold plus moving window approach described above.

Working Example 8 in FIG. 17 illustrates confirmation of the fall detection decision of Working Example 7 using the reference fall wavelet comparison technique described above. Further, Working Example 8 also illustrates that it is possible to detect a fall using only the reference fall wavelet comparison technique. Thus, for the shaded data, e.g., the moving window describe above, the waveform is compared with the reference fall waveform. In this case, the waveform matches the reference wavelet at 90%, meeting the predetermined match threshold, confirming the fall detection of Working Example 7 or, alternatively, detecting a fall without prior analysis of upper/lower thresholds and/or moving window implementation.

The skilled artisan will now recognize that it is possible to detect a fall with the system described herein by (1) upper and lower thresholds alone; (2) upper and lower thresholds within an established window; (3) upper and lower thresholds within a window that moves across the data; (4) upper and lower thresholds within a window in combination with waveform comparison with a reference wavelet; and (5) waveform comparison with a reference wavelet.

The present invention should not be considered limited to the particular examples described above, but rather should be understood to cover all aspects of the invention. Various modifications, equivalent processes, as well as numerous structures to which the present invention may be applicable will be readily apparent to those of skill in the art to which the present invention is directed upon review of the present specification.

What is claimed is:

1. A fall detection method for a wearable device comprising a 3-axis accelerometer and a processor in communication with the accelerometer, wherein the fall detection method is not initiated unless a significant movement threshold is exceeded.

2. The method of claim 1, wherein the fall detection method further comprises:
establishing an upper movement threshold;
establishing a lower movement threshold;
obtaining acceleration data from a 3-axis accelerometer over a predetermined time;
comparing the obtained acceleration data with the upper and lower movement thresholds; and
detecting a fall only if at least one acceleration data point exceeds the upper movement threshold and if the acceleration data remains below the lower movement threshold.

3. The method of claim 2, wherein the upper movement threshold is 30 m/s² and the lower movement threshold is 20 m/s².

4. The method of claim 2, further comprising:
establishing a window for the obtained acceleration data; and
detecting a fall only at least one acceleration data point exceeds the upper movement threshold within the established window and if the acceleration data remains below the lower movement threshold after exceeding the upper movement threshold within the established window.

5. The method of claim 5, wherein the established window moves step-wise along the obtained acceleration data.

6. The method of claim 1, further comprising:
establishing a reference fall waveform indicative of fall movements; and
obtaining acceleration data over a predetermined time;
transforming the obtained acceleration data into a waveform;
comparing the waveform with the reference wavelet; and
detecting a fall only if the waveform matches the reference wavelet above a predetermined level of matching.

7. The method of claim 6, further comprising establishing a window for the obtained acceleration data; and
detecting a fall only at least one acceleration data point exceeds the upper movement threshold within the established window and if the acceleration data ends remains below the lower movement threshold after the upper movement threshold is exceeded within the established window.

8. The method of claim 7, wherein the established window moves step-wise along the obtained acceleration data.

9. The method of claim 1, wherein the wearable device remains in a low-power mode until a fall is detected.

10. The method of claim 9, further comprising initiating an emergency event process when a fall is detected.

11. The method of claim 10, further comprising actuating a countdown timer when the emergency event process is initiated and a cancellation option displayed on the wearable device that may be actuated to interrupt the emergency process.

12. The method of claim 11, further comprising storing the initiating of the emergency event process.

13. The method of claim 10, further comprising sending an emergency event message to a cloud-based emergency service, initiating a phone call to an emergency center, and sending SMS messages to identified delegates.

14. The method of claim 9, wherein remotely located users may access a web-based dashboard comprising data from the wearable device and request a current telemetry inquiry for the device.

15. The method of claim 14, wherein the device partially wakes up in order to get its location, battery life information and heart rate.

16. A fall detection method for a wearable device comprising:
establishing a reference fall waveform indicative of fall movements;
obtaining acceleration data over a predetermined time;
transforming the obtained acceleration data into a waveform;
comparing the waveform with the reference wavelet; and
detecting a fall only if the waveform matches the reference wavelet above a predetermined level of matching.

17. The method of claim 16, further comprising establishing a window for the obtained acceleration data; and
confirming the detected fall only if at least one acceleration data point exceeds the upper movement threshold within the established window and the acceleration data remains below the lower movement threshold after exceeding the upper movement threshold within the established window.

18. A wearable device comprising:
a processor configured to execute programmed instructions;
an internal memory configured to store the programed instructions and in operative communication with the processor;
a sensor hub configured to sense movements of the wearable device and in operative communication with the processor and the internal memory;
a cellular module in operative communication with the processor; and
wherein the programmed instructions adapted to execute the method of claim 7.

19. The wearable device of claim 18, wherein if a fall is detected after execution of the programmed instructions, a emergency process is initiated by the wearable device.

20. The wearable device of claim 19, wherein the emergency process comprises initiating a phone call to a designated phone number and sending at least one SMS message to a communication device of least one predesignated delegate.
